(19) United States
(12) Patent Application Publication
(10) Pub. No.: US 2006/0129601 A1
(43) Pub. Date: Jun. 15, 2006

(54) System, computer program product and method of collecting metadata of application programs installed on a computer system

(75) Inventors: David Yu Chang, Austin, TX (US); William Mitchell Edwards, Pflugerville, TX (US); Leigh Allen Williamson, Austin, TX (US)

Correspondence Address: IBM CORPORATION (VE);C/O VOLEL EMILE, P. O. BOX 202170, AUSTIN, TX, 78720-2170, US

(73) Assignee: International Business Machines Corporation, Armonk, NY (US)

(21) Appl. No.: 11/008,796

(22) Filed: Dec. 9, 2004

(51) Int. Cl. G06F 17/00

(52) U.S. Cl. 707/104.1

(57) ABSTRACT

A system, computer program product and method of collecting metadata of application programs installed on a computer system are provided. A check is generally performed to determine whether metadata of an application program is to be collected. If so, the metadata is automatically collected and stored. The collected metadata may be provided to a system managing the computer system upon request. The check may be performed periodically. If the check is performed periodically, however, it is always performed before providing metadata to the managing system.

### BACKGROUND OF THE INVENTION

1. Technical Field

The present invention is directed to distributed networks. More specifically, the present invention is directed to a system, computer program product and method of automatically collecting metadata of application programs installed on computer systems in a distributed network.

2. Description of Related Art

In a distributed network, there generally is a plurality of computer systems that may each have a different operating system (OS) installed thereon. Further, the computer systems may be executing different application programs and/or different versions of the application programs. It is well known that the capability of a computer system is based on the software packages that are installed thereon. Thus, if the different computer systems in the distributed network have different OSs, different application programs and/or different versions of the application programs installed thereon, they may each provide different features or have different capabilities. For the purpose of the invention, OSs and application programs will all be referred to generically as application programs.

Often times, the computer systems in a distributed network are managed by an application server. An application server is a server program in a computer system that facilitates interaction of the application programs in the network. In order to do so, however, the application server needs to know which feature is provided by which computer system (i.e., which application programs are installed on which computer system) in the distributed network. This is generally accomplished through metadata.

Metadata is information about data. Data, in this case, includes any file in a file system whether it is code data as in the case of application programs or plain old data. Put differently, metadata is structured data which consists of a number of pre-defined elements representing specific attributes of a file, and each element can have one or more values. For example, a file system may contain access permission, ownership, creation date, et cetera (i.e., metadata) about each file (i.e., data) stored therein. Thus, metadata describes how, when and/or by whom a particular set of data was collected as well as how the data is formatted.

Presently, metadata is statically collected and provided to the application server either as part of a software product installation or through explicit user entry. When the software product is uninstalled, its metadata may be statically deleted. For computer systems (e.g., servers) that use thousands of files, a system administrator may have to painstakingly manage the metadata. This can be quite a daunting task.

Thus, what is needed is a system, computer program product and method of automatically collecting metadata of application programs installed on a computer system such that the metadata may be automatically provided to an application server that is managing the computer system in the network. The system, computer program product and method may automatically delete metadata of application programs that have been uninstalled from the computer system.

### SUMMARY OF THE INVENTION

The present invention provides a system, computer program product and method of collecting metadata of application programs installed on a computer system. Periodically, a check is performed to determine whether metadata of an application program is to be collected. Generally, metadata of an application program is to be collected if the application program has been newly installed on the computer system or has been updated. If metadata is to be collected, a file containing the metadata of the application program is accessed, parsed for relevant metadata information and the relevant information stored in a metadata master file. The metadata master file is a file in which metadata of all the application programs installed on the system is stored.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a conceptual view of a cell in a distributed network.

FIG. 2 depicts an exemplary metadata in tabular form.

FIG. 3 depicts an HTML document representing an exemplary metadata.

FIG. 4 is a flowchart implementing the present invention.

FIG. 4 is an exemplary block diagram illustrating a distributed data processing in which the present invention may be implemented.

FIG. 6 is an exemplary block diagram of a server apparatus according to the present invention.

FIG. 7 is an exemplary block diagram of a client apparatus according to the present invention.

### DETAILED DESCRIPTION OF THE PREFERRED EMBODIMENT

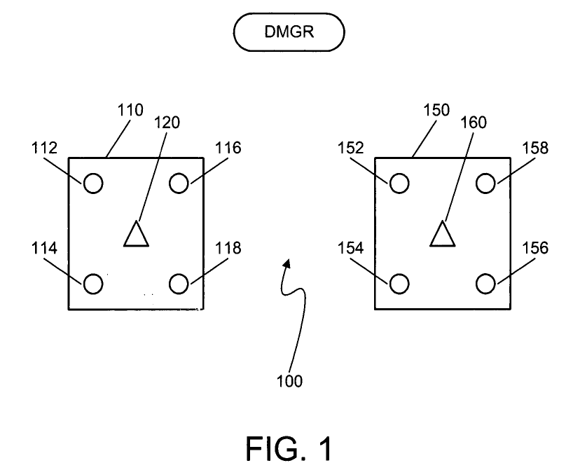

Application servers, such as IBM Websphere Application Server (WAS), generally configure computing systems in a distributed network in a plurality of cells. Each cell may contain a plurality of logical nodes. FIG. 1 depicts a conceptual view of a cell 100 in a distributed network. The cell 100 contains two logical nodes, node₁ 110 and node₂ 150.

Generally, a node may be a computing system (e.g., a computer system, or a switch, or a router, et cetera). In such a case, items 112, 114, 116 and 118 in node₁ 110 and 152, 154, 156 and 158 in node₂ 150 may be applications programs (e.g., firewall, OS, node group server process, application server process, database system, Web server, Java 2 Platform Enterprise Edition (J2EE) application programs, et cetera). The OS may be either AIX (a product of IBM, Corp.), or Solaris (a product of Sun Microsystems), or Linux, or Microsoft Windows, et cetera.

The cell 100 also has a deployment manager (DMgr) 170. The DMger 170 may be installed on any one of the computing systems in the cell 100 or may be a computing system dedicated to provide such service. The DMgr 170 handles the system management and configuration of the entire cell 100.

Each node in the cell 100 has a node agent. For example, node₁ 110 has node agent 120 and node₂ 150 has node agent 160. A node agent is an application program that is used to synchronize node configuration data with cell configuration data. For example, if an application program is added to node₁ 110, the node agent 120 may obtain the metadata of the newly added application program and forward it to the DMgr 170 upon request.

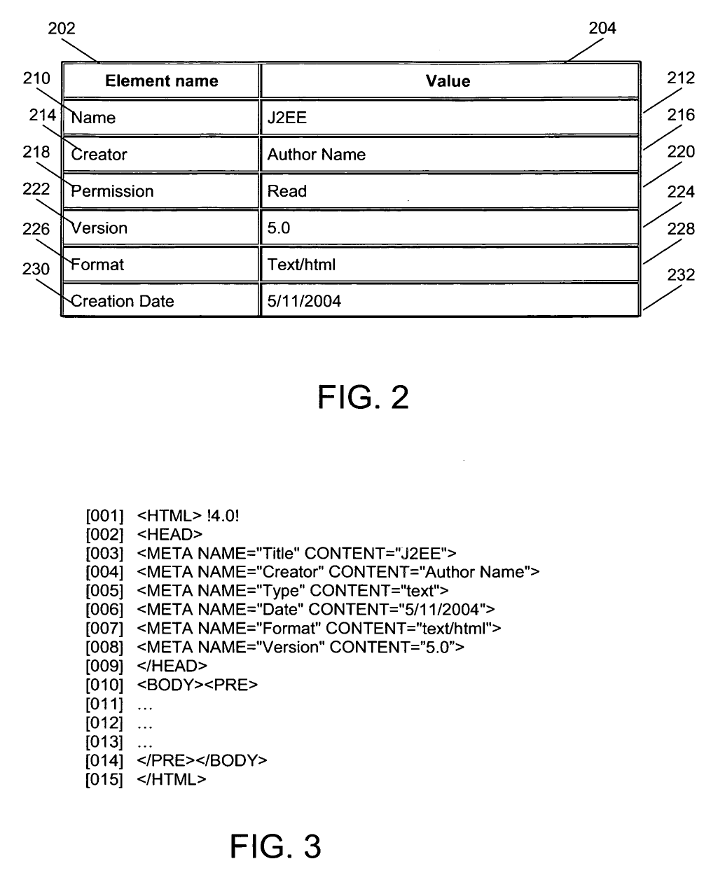

The DMgr 170 may request metadata from a node agent when instructed to do so by WAS or any other application server or network managing system in the network. For example, there are certain J2EE methods that can only be invoked on J2EE version 5.0 via WAS version 5.0. Thus, a system administrator using a client on which WAS version 5.0 is installed may want to know on which one of the computing systems in a distributed network is J2EE version 5.0 running before invoking those methods. In such a case, therefore, the system administrator may query the computing systems in the distributed network for the metadata of the application programs, in general, and J2EE, in particular, installed thereon. The client then may send the request to each DMgr 170 (i.e., to each cell) in the distributed network. Each DMgr 170 may then send a request to each one of the node agents it is administrating. Each node agent may forward the metadata of the application programs installed in that node to the DMgr 170, which will then relay the metadata to the requesting client. If, for instance, J2EE version 5.0 is running on node₁ 110, then FIG. 2 may be one of the information data relayed back to the requesting client.

FIG. 2 depicts an exemplary metadata in tabular form. Each element name 202 in the metadata is cross-referenced with a value 204. For example, “name” 210 of the application program is cross-referenced with “J2EE” 212. Likewise “creator” 210 of the application program is cross-referenced with “author name” 216, “permission” 218 is cross-referenced with “read” 220, “version” 222 is cross-referenced with “5.0” 224, “format” 226 with “text/html” 228 and “creation” date 230 with “May 11, 2004” 232. Upon receiving this information, the client will then know that the J2EE methods are to be invoked on node₁ 110 of the distributed network since J2EE version 5.0 is installed on that node.

The metadata may be deployed in a number of ways. For example, the metadata may be integrated into the application program it describes. Alternatively, the metadata may be in a document that is linked to the application program or extracted from another source, such as a Web page. Further, the metadata may be in HTML (Hyper-Text Markup Language), SGML (Standard Generalized Markup Language), XML (extensible Markup Language), RDF (Resource Description Framework), MARC (MAchine Readable Cataloging), MIME (Multipurpose Internet Mail Extensions), in plain tabular form or any other format.

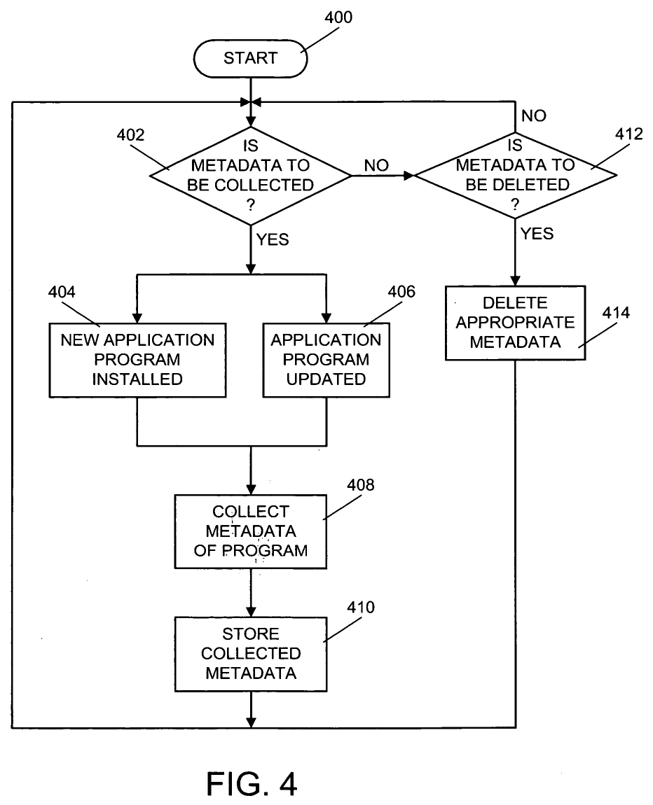

FIG. 3 depicts an HTML document representing an exemplary metadata. In this example, the HTML document encodes the metadata shown in FIG. 2. In the HTML document, META tags are used to identify the different elements and their value. For example, the different elements in FIG. 2 and their respective value are on line [003] to line [008]. Line [001], line [002] and lines [009]-[015]) are used to ensure that the HTML document is a well formed document.

In operation, when J2EE version 5.0 is installed on node₁ 110, node agent 120 may access the HTML document shown in FIG. 3 (i.e., the J2EE metadata file), parse the HTML document to extract the relevant information (i.e., title, creation date, format, version, et cetera). After doing so, agent 120 may store the extracted information in a metadata master file (i.e., a file that contains metadata for all the programs installed on the node) or in a database. Obviously, the extracted information may be stored in tabular form or in any other form imaginable so long as metadata of one application program is distinguishable from metadata of other application programs. Being able to distinguish metadata of one application program from others allows a particular metadata to be updated or deleted altogether from the file when the application program to which it pertains is updated or uninstalled from the node, respectively.

For example, suppose the master file is a metadata folder, then each subfolder may be associated with an application program (e.g., may be given the name of an application program) that is installed on the node. Metadata of each application program installed on the node will then be stored in the appropriate sub-folder. As mentioned above, the metadata itself may be in any form. When an application program is uninstalled from the node, then the subfolder (and its content) associated with the uninstalled program may be deleted from the metadata folder. When an application program is updated, the information in its metadata subfolder may also be updated. In sum, the metadata folder may always contain metadata of current versions of the application programs installed on the node.

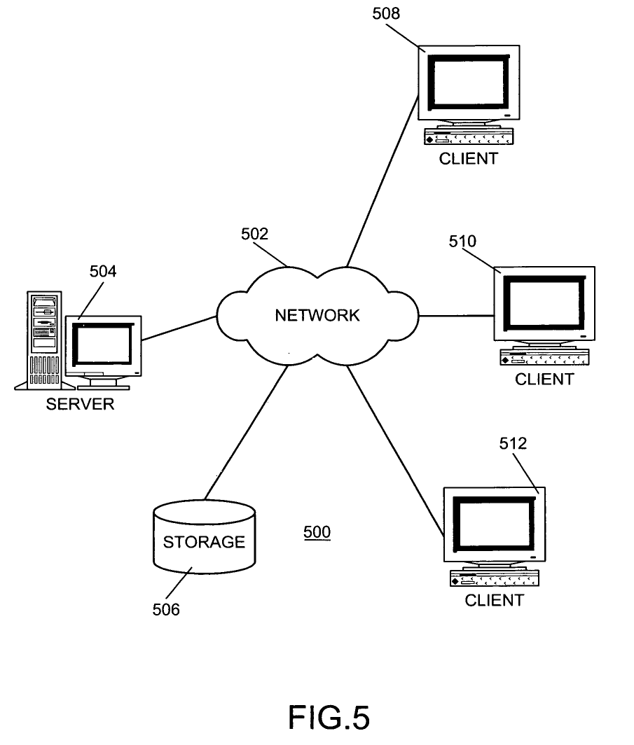

FIG. 4 is a flow chart of a process that may be used to implement the invention. The process starts when a computing system on which a node agent is installed is turned on or is reset (step 400). A check may continuously be made to determine whether metadata is to be collected (step 402). Alternatively, the check may be made periodically. If the check is made periodically, it will always have to be made before the node agent forwards metadata information to a requesting DMger or client.

In any case, metadata is to be collected whenever a new application program has been installed on the node (step 404) or a previously installed application program has been updated (step 406). If metadata is to be collected either because one or more application programs have been installed and/or updated, the node agent will collect the metadata of each application program by serially accessing the metadata file of all newly installed and/or updated application programs, parse each accessed file for the relevant information and store the collected information in appropriate locations on a storage device (steps 408 and 410). After doing so, the process may return to step 402.

If metadata is not to be collected, another check may be made to determine whether metadata is to be deleted (step 412). As mentioned before, metadata of an application program may be deleted if the application program has been uninstalled from a node. If there is one or more application programs that have been uninstalled, then the metadata of all the uninstalled application programs may be deleted (step 414). After deleting the metadata of all uninstalled application programs, the process may return to step 412.

To determine which application programs have been newly installed, the node agent may keep a file for all newly installed application programs. Likewise, the node agent may keep a file for all updated application programs as well as a file for all deleted application programs. Hence, the node agent needs only consult those files to determine whether to collect or delete metadata. The process may end when the computing system on which the node agent is installed is turned off.

FIG. 5 depicts a pictorial representation of a network of data processing systems in which the present invention may be implemented. Network data processing system 500 is a network of computers in which the present invention may be implemented. Network data processing system 500 contains a network 502, which is the medium used to provide communications links between various devices and computers connected together within network data processing system 500. Network 102 may include connections, such as wire, wireless communication links, or fiber optic cables.

In the depicted example, server 504 is connected to network 502 along with storage unit 506. In addition, clients 508, 510, and 512 are connected to network 502. These clients 508, 510, and 512 may be, for example, personal computers. In the depicted example, server 504 provides data, such as boot files, operating system images, and applications to clients 508, 510 and 512. Clients 508, 510 and 512 are clients to server 504. Network data processing system 500 may include additional servers, clients, and other devices not shown. In the depicted example, network data processing system 500 is the Internet with network 502 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 500 also may be implemented as a number of different types of networks, such as for example, an intranet, a local area network (LAN), or a wide area network (WAN). FIG. 5 is intended as an example, and not as an architectural limitation for the present invention.

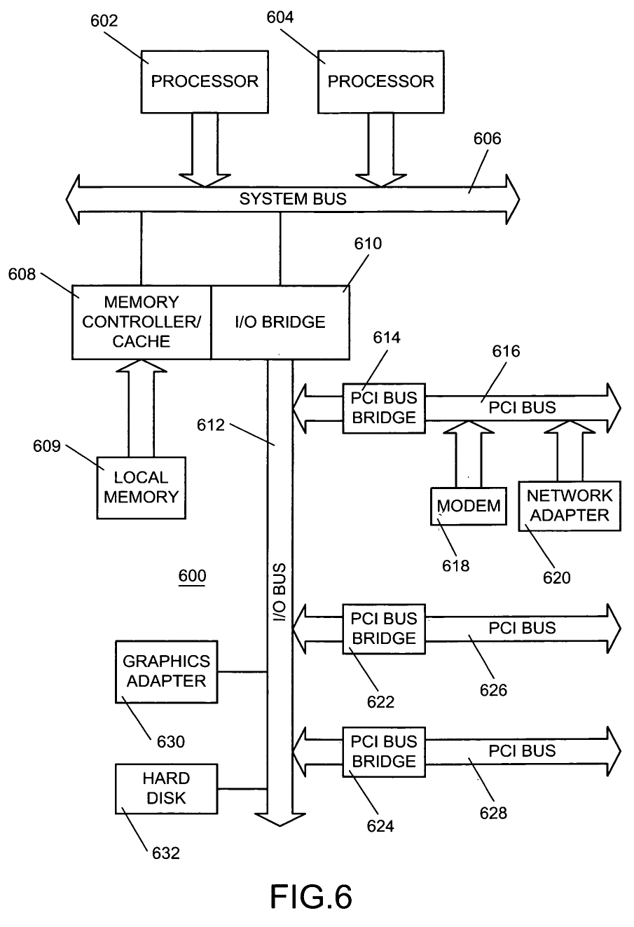

Referring to FIG. 6, a block diagram of a data processing system that may be implemented as a server, such as server 504 in FIG. 5, is depicted in accordance with a preferred embodiment of the present invention. Data processing system 600 may be a symmetric multiprocessor (SMP) system including a plurality of processors 602 and 604 connected to system bus 606. Alternatively, a single processor system may be employed. Also connected to system bus 606 is memory controller/cache 608, which provides an interface to local memory 609. I/O bus bridge 610 is connected to system bus 606 and provides an interface to I/O bus 612. Memory controller/cache 608 and I/O bus bridge 610 may be integrated as depicted.

Peripheral component interconnect (PCI) bus bridge 614 connected to I/O bus 612 provides an interface to PCI local bus 616. A number of modems may be connected to PCI local bus 616. Typical PCI bus implementations will support four PCI expansion slots or add-in connectors. Communications links to network computers 508, 510 and 512 in FIG. 5 may be provided through modem 618 and network adapter 620 connected to PCI local bus 616 through add-in boards.

Additional PCI bus bridges 622 and 624 provide interfaces for additional PCI local buses 626 and 628, from which additional modems or network adapters may be supported. In this manner, data processing system 600 allows connections to multiple network computers. A memory-mapped graphics adapter 630 and hard disk 632 may also be connected to I/O bus 612 as depicted, either directly or indirectly.

Those of ordinary skill in the art will appreciate that the hardware depicted in FIG. 6 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 6 may be, for example, an IBM e-Server pSeries system, a product of International Business Machines Corporation in Armonk, N.Y., running the Advanced Interactive Executive (AIX) operating system or LINUX operating system.

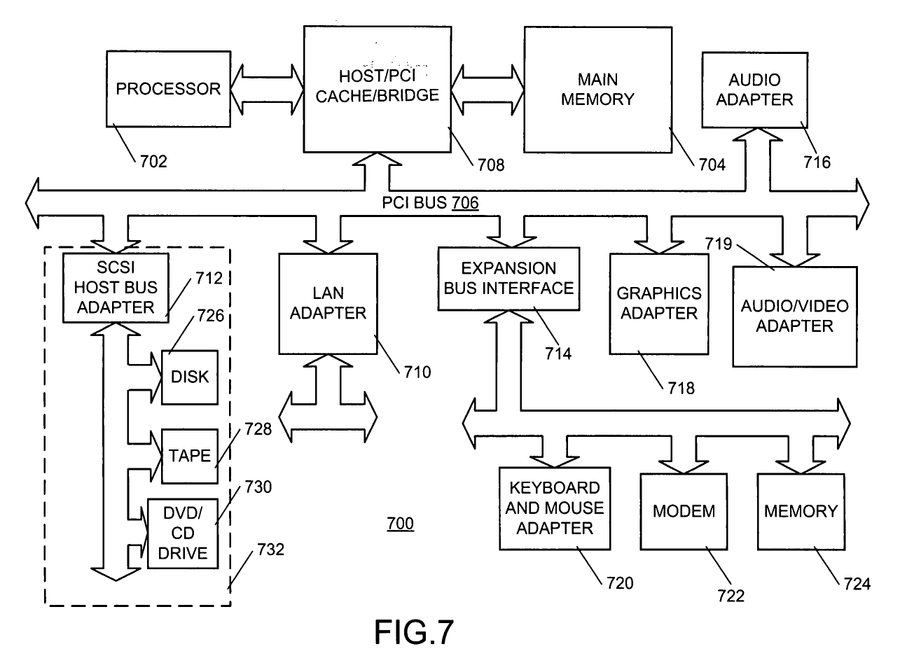

With reference now to FIG. 7, a block diagram illustrating a data processing system is depicted in which the present invention may be implemented. Data processing system 700 is an example of a client computer. Data processing system 700 employs a peripheral component interconnect (PCI) local bus architecture. Although the depicted example employs a PCI bus, other bus architectures such as Accelerated Graphics Port (AGP) and Industry Standard Architecture (ISA) may be used. Processor 702 and main memory 704 are connected to PCI local bus 706 through PCI bridge 708. PCI bridge 708 also may include an integrated memory controller and cache memory for processor 702. Additional connections to PCI local bus 706 may be made through direct component interconnection or through add-in boards. In the depicted example, local area network (LAN) adapter 710, SCSI host bus adapter 712, and expansion bus interface 714 are connected to PCI local bus 706 by direct component connection. In contrast, audio adapter 716, graphics adapter 718, and audio/video adapter 719 are connected to PCI local bus 706 by add-in boards inserted into expansion slots. Expansion bus interface 714 provides a connection for a keyboard and mouse adapter 720, modem 722, and additional memory 724. Small computer system interface (SCSI) host bus adapter 712 provides a connection for hard disk drive 726, tape drive 728, and CD-ROM/DVD drive 730. Typical PCI local bus implementations will support three or four PCI expansion slots or add-in connectors.

An operating system runs on processor 702 and is used to coordinate and provide control of various components within data processing system 700 in FIG. 7. The operating system may be a commercially available operating system, such as Windows XP™, which is available from Microsoft Corporation. An object oriented programming system such as Java may run in conjunction with the operating system and provide calls to the operating system from Java programs or applications executing on data processing system 700. “Java” is a trademark of Sun Microsystems, Inc. Instructions for the operating system, the object-oriented operating system, and application programs and the present invention are located on storage devices, such as hard disk drive 726, and may be loaded into main memory 704 for execution by processor 702.

Those of ordinary skill in the art will appreciate that the hardware in FIG. 7 may vary depending on the implementation. Other internal hardware or peripheral devices, such as flash ROM (or equivalent nonvolatile memory) or optical disk drives and the like, may be used in addition to or in place of the hardware depicted in FIG. 7. Also, the processes of the present invention may be applied to a multiprocessor data processing system.

As another example, data processing system 700 may be a stand-alone system configured to be bootable without relying on some type of network communication interface, whether or not data processing system 700 comprises some type of network communication interface. As a further example, data processing system 700 may be a Personal Digital Assistant (PDA) device or a router et cetera, which is configured with ROM and/or flash ROM in order to provide non-volatile memory for storing operating system files and/or user-generated data.

The depicted example in FIG. 7 and above-described examples are not meant to imply architectural limitations. For example, data processing system 70 may also be a notebook computer or hand held computer. Data processing system 700 also may be a kiosk or a Web appliance.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of collecting metadata of application programs installed on a computer system comprising the steps of:
determining whether one or more application programs have been newly installed or updated on the computer system;
automatically collecting, if one or more application programs have been newly installed or updated, metadata of each one of the application programs that has been newly installed or updated; and
storing the collected metadata in a metadata master file.

2. The method of claim 1 wherein the collected metadata is stored in the metadata master file such that metadata of one application program is distinguishable from metadata of other application programs.

3. The method of claim 2 wherein metadata of an application program that has been uninstalled from the computer system is deleted from the metadata master file.

4. The method of claim 3 wherein the stored metadata is provided to a managing system upon request.

5. The method of claim 4 wherein the determining step occurs each time the collected metadata is to be provided to the managing system.

6. The method of claim 1 wherein the automatically collecting step includes the step of serially accessing files containing metadata of the one or more application programs and parsing each accessed file for relevant metadata information.

7. A computer program product on a computer readable medium for collecting metadata of application programs installed on a computer system comprising:
code means for determining whether one or more application programs have been newly installed or updated on the computer system;
code means for automatically collecting, if one or more application programs have been newly installed or updated on the computer system, metadata of each one of the application programs that has been newly installed or updated; and
code means for storing the collected metadata in a metadata master file.

8. The computer program product of claim 7 wherein the collected metadata is stored in the metadata master file such that metadata of one application program is distinguishable from metadata of other application programs.

9. The computer program product of claim 8 wherein metadata of an application program that has been uninstalled from the computer system is deleted from the metadata master file.

10. The computer program product of claim 9 wherein the stored metadata is provided to a managing system upon request.

11. The computer program product of claim 10 wherein the determining step occurs each time the collected metadata is to be provided to the managing system.

12. The computer program product of claim 7 wherein the automatically collecting step includes the step of serially accessing files containing metadata of the one or more application programs and parsing each accessed file for relevant metadata information.

13. A computer system being capable of automatically collecting metadata of application programs installed thereon comprising:
at least one storage device for storing code data; and
at least one processor for processing the code data to determine whether one or more application programs have been newly installed or updated thereon, to automatically collect, if one or more application programs have been newly installed or updated thereon, metadata of each one of the application programs that has been newly installed or updated, and to store the collected metadata in a metadata master file.

14. The computer system of claim 13 wherein the collected metadata is stored in the metadata master file such that metadata of one application program is distinguishable from metadata of other application programs.

15. The computer system of claim 14 wherein metadata of an application program that has been uninstalled from the computer system is deleted from the metadata master file.

16. The computer system of claim 15 wherein the stored metadata is provided to a managing system upon request.

17. The computer system of claim 16 wherein the determining step occurs each time the collected metadata is to be provided to the managing system.

18. The computer system of claim 13 wherein the automatically collecting step includes the step of serially accessing files containing metadata of the one or more application programs and parsing each accessed file for relevant metadata information.
